(19) United States
(12) Patent Application Publication
(10) Pub. No.: US 2013/0141673 A1
(43) Pub. Date: Jun. 6, 2013

(54) Liquid Crystal Display Panel and Liquid Crystal Display

(71) Applicants: Xiaolong Ma, Guangdong (CN); Yahui Chen, Guangdong (CN)

(72) Inventors: Xiaolong Ma, Guangdong (CN); Yahui Chen, Guangdong (CN)

(21) Appl. No.: 13/379,069

(22) PCT Filed: Dec. 6, 2011
(86) PCT No.: PCT/CN11/83574

§ 371 Date: Dec. 19, 2011

(30) Foreign Application Priority Data
Dec. 2, 2011 (CN) 2011103961929

(51) Int. Cl. G02F 1/1335

(52) U.S. Cl. 349/96

(57) ABSTRACT

The present invention discloses a liquid crystal display (LCD) panel and an LCD. The LCD panel comprises an array substrate of which the bottom is provided with a lower polaroid. In the LCD panel, a retardation film is arranged only between the array substrate and the lower polaroid. The LCD panel of the present invention only arranges the retardation film between the array substrate and the lower polaroid. Because the LCD panel uses a mode of monolayer compensation and the retardation film is not arranged between a color filter plate and an upper polaroid, a layer of retardation film is omitted. In this way, not only the visual angle of the LCD is optimized, but also the material of the retardation film is saved. Thus, the cost of the LCD is reduced. Besides, the retardation film is arranged between the lower substrate and the lower polaroid, so the rate of rework is reduced to avoid wasting the retardation film.

### TECHNICAL FIELD

The present invention relates to the field of liquid crystal displays, and more particularly to a liquid crystal display panel and a liquid crystal display.

### BACKGROUND

A liquid crystal display (LCD) has an upper substrate and a lower substrate, and a transparent electrode is arranged in the opposite inside of two substrates. A layer of liquid crystal molecules is champed between two substrates. The LCD changes the polarization state of light by controlling the orientation of the liquid crystal molecules by an electric field, as well as penetrates and stops the optical path via a polaroid to achieve displaying. In accordance with the different initial permutation of the liquid crystal molecules, the LCD may fall into TN type, IPS type, VA type, etc., wherein the VA type has the characteristics of high contrast and wide viewing angle because the initial liquid crystal molecules are perpendicular to the substrates.

In the VA type, the upper polaroid and the lower polaroid are perpendicular and parallel to each other. Observed from the front, the rays of light cannot pass through without the electric field, so the normal black display is formed.

But observed from the side, the VA type will have the problem of dark-state light leakage for the following reasons:

1. Observed from the front, the optical path corresponds to an optical axis of the liquid crystal molecule, without an optical retardation; while observed from the side, the optical path will induce the optical retardation because there is an angle included by the optical path and the optical axis of the liquid crystal molecules, and thus the polarization state of light is changed and the light is leaked out.

2. Observed from the front, the absorption axes of the upper polaroid and the lower polaroid are parallel to each other, so the optical path can be obstructed completely; while observed from the side, the absorption axes of the upper polaroid and the lower polaroid are intersected obliquely, so the light leakage is induced.

The patent documentation US2006/0203150A1 discloses on May 27, 2008 an LCD which is operated in the mode of vertical arrangement. The LCD comprises an LC layer, a first substrate, a second substrate, a first polaroid, and a second polaroid. Wherein: the LC layer is placed between the first substrate and the second substrate; the first polaroid is arranged near a surface of the first substrate which is opposite to the surface of one of the LC layer that faces the first polaroid; a first gap is arranged between the first polaroid and the first substrate; the second polaroid is arranged near a surface of the second substrate which is opposite to the surface of one of the LC layer that faces the second polaroid; and a second gap is arranged between the second polaroid and the second substrate. Besides, at least one of the first gap and the second gap comprises a first delay film (retardation film) with a positive non-isotropic of light and a second delay film with a negative non-isotropic of light; and the first delay film is arranged near the LC layer with respect to the second delay film.

The patent documentation discloses the double-decked delay film. The delay film can be used for improving the visual angle of the LCD arranged vertically, but the double-decked retardation film is required to be used. Thus, the cost of materials is higher and the rate of rework is also higher.

### SUMMARY

One aim of the present invention is to provide an LCD panel and an LCD which improves the visual angle of the LCD arranged vertically and has the characteristics of low cost and low rate of rework.

The purpose of the present invention is achieved by the following technical schemes.

An LCD panel comprises an array substrate of which the bottom is provided with a lower polaroid. In the LCD panel, a retardation film is only arranged between the array substrate and the lower polaroid.

Preferably, the retardation film is a biaxial retardation film which can stretch and compensate the rays of light in the X and Y directions to improve the visual angle of the LCD device.

Preferably, a slow axis of the retardation film is perpendicular to an absorption axis of the lower polaroid. This is one specific embodiment of the retardation film.

Preferably, the slow axis of the retardation film is parallel to the absorption axis of the lower polaroid. This is one specific embodiment of the retardation film.

Preferably, the retardation (Nx−Ny)*d within the plane of the retardation film is limited to 60-100 nm, which can achieve the best effect of compensation.

An LCD comprises the LCD panel comprising the array substrate of which the bottom is provided with the lower polaroid. In the LCD panel, the retardation film is arranged only between the array substrate and the lower polaroid.

Preferably, the retardation film is the biaxial retardation film which can stretch and compensate the rays of light from the X and Y directions to improve the visual angle of the LCD device.

Preferably, a slow axis of the retardation film is perpendicular to an absorption axis of the lower polaroid. This is one specific embodiment of the retardation film.

Preferably, the slow axis of the retardation film is parallel to the absorption axis of the lower polaroid. This is one specific embodiment of the retardation film.

Preferably, the retardation (Nx−Ny)*d within the plane of the retardation film is limited to 60-100 nm, which can achieve the best effect of compensation.

The LCD panel of the present invention only arranges the retardation film between the array substrate and the lower polaroid. Because the LCD panel uses the mode of monolayer compensation and the retardation film is not arranged between the color filter plate and the upper polaroid, a layer of retardation film is omitted. In this way, not only the visual angle of the LCD is optimized, but also the material of the retardation film is saved. Thus, the cost of the LCD is reduced. Besides, the retardation film is arranged between the lower substrate and the lower polaroid, so the rate of rework is reduced to avoid wasting the retardation film.

### BRIEF DESCRIPTION OF FIGURES

FIG. 1 is a schematic diagram of a slow axis of a retardation film perpendicular to an absorption axis of a lower polaroid of the present invention;

FIG. 2 is a schematic diagram of a slow axis of a retardation film parallel to an absorption axis of a lower polaroid of the present invention;

Wherein: 10a. upper substrate; 10b. lower substrate; 12. LC layer; 14a. upper polaroid; 14b. lower polaroid; 16a. absorption axis of upper polaroid; 16b. absorption axis of lower polaroid; 18b. retardation film; 20. slow axis of retardation film.

### DETAILED DESCRIPTION

The present invention will further be described in detail in accordance with the figures and the preferred embodiments.

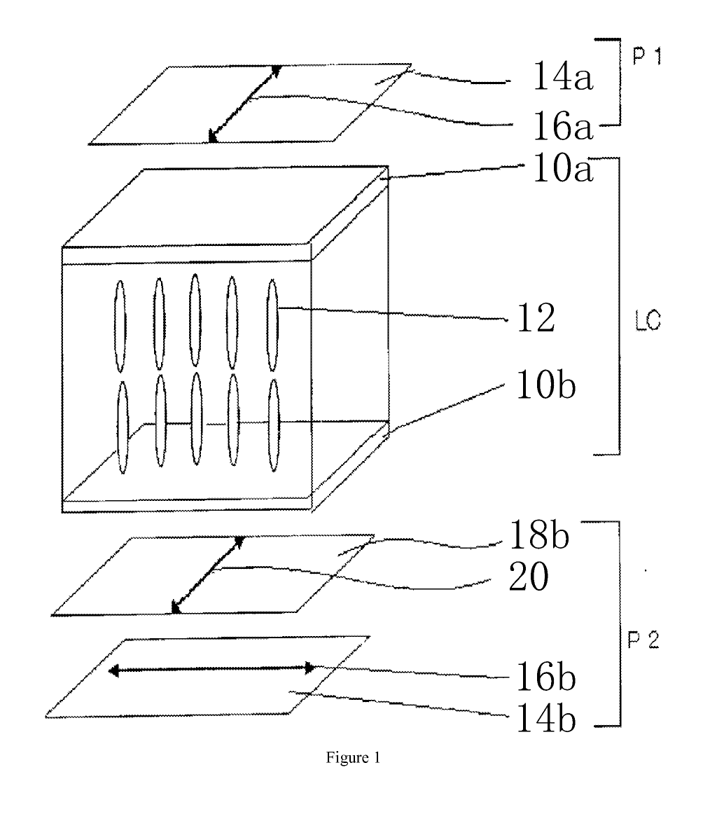

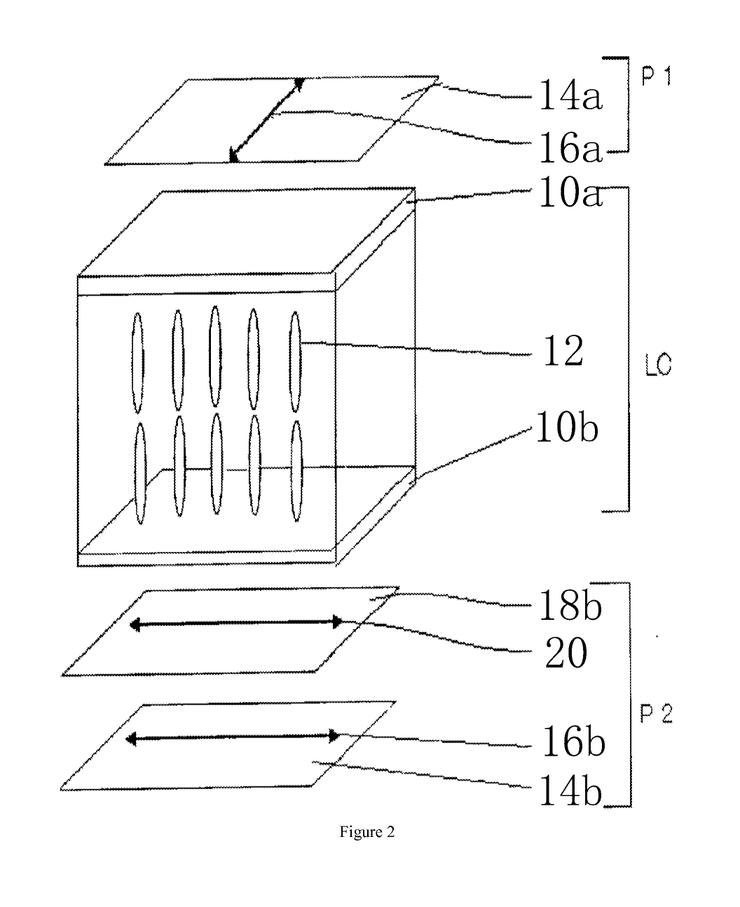

As shown in FIG. 1 and FIG. 2, the LCD comprises the LCD panel comprising the upper substrate 10a and the lower substrate 10b, wherein the upper substrate 10a and the lower substrate 10b are mutually and oppositely arranged; there is a Δε <0 negative LC layer 12 between the upper substrate 10a and the lower substrate 10b; the upper polaroid 14a and the lower polaroid 14b are respectively closely arranged on the outside of the upper substrate 10a and that of the lower substrate 10b; and the absorption axis of upper polaroid 16a and the absorption axis of lower polaroid 16b are parallel to each other. Besides, a layer of biaxial retardation film 18b is arranged between the upper substrate 10a and the lower polaroid 14b; the slow axis of retardation film 20 is perpendicular or parallel to the absorption axis of lower polaroid 16b; and the retardation (Nx−Ny)*d within the plane of the retardation film is limited to 60-100 nm.

The retardation (Nx−Ny)*d within the plane of the monolayer retardation film 18b used in the present invention is limited to 60-100 nm, and the retardation film 18b is closely arranged between the lower substrate and the lower polaroid. Wherein, Nx refers to the direction of providing the largest refractive index within the plane, i.e. the refractive index in the direction of the slow axis; Ny refers to the direction perpendicular to that of the slow axis within the same plane, i.e. the refractive index in the direction of the fast axis; Nx>Ny; and d refers to the thickness of the retardation film 18b.

For resolving the color shift and other problems, the monolayer retardation film is weaker than the double-decked retardation film; but with the notable cost-effectiveness, the monolayer retardation film can be applied to the LCD that does not require the higher quality of pictures.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

1. A liquid crystal display (LCD) panel, wherein said LCD panel comprises an array substrate; the bottom of said array substrate is provided with a lower polaroid; and said LCD panel is only provided with a retardation film between said array substrate and said lower polaroid.

2. The LCD panel of claim 1, wherein said retardation film is a biaxial retardation film.

3. The LCD panel of claim 1, wherein a slow axis of said retardation film is perpendicular to an absorption axis of said lower polaroid.

4. The LCD panel of claim 1, wherein a slow axis of said retardation film is parallel to the absorption axis of said lower polaroid.

5. The LCD panel of claim 1, wherein the retardation (Nx−Ny)*d within the plane of said retardation film is limited to 60-100 nm.

6. A Liquid crystal display (LCD), wherein said LCD comprises the LCD panel comprising an array substrate; the bottom of said array substrate is provided with the lower polaroid; in said LCD panel, the retardation film is only arranged between said array substrate and said lower polaroid.

7. The LCD of claim 6, wherein said retardation film is a biaxial retardation film.

8. The LCD of claim 6, wherein the slow axis of said retardation film is perpendicular to the absorption axis of said lower polaroid.

9. The LCD of claim 6, wherein the slow axis of said retardation film is parallel to the absorption axis of said lower polaroid.

10. The LCD of claim 6, wherein the retardation (Nx−Ny)*d within the plane of said retardation film is limited to 60-100 nm.
